(19) United States
(12) Patent Application Publication
(10) Pub. No.: US 2015/0149482 A1
(43) Pub. Date: May 28, 2015

(54) Using Live Information Sources To Rank Query Suggestions

(71) Applicant: Google Inc., Mountain View, CA (US)

(72) Inventors: Lev Finkelstein, Haifa (IL); Yaroslav Volovich, Cambridge (GB)

(21) Appl. No.: 13/830,035

(22) Filed: Mar. 14, 2013

(51) Int. Cl. G06F 17/30

(52) U.S. Cl. CPC G06F 17/3053
USPC 707/748

(57) ABSTRACT

Methods and apparatus related to identifying one or more representative features of a live information source and ranking query suggestions based on the representative features. In some implementations the representative feature may be identified directly from the live information source. In some implementations the representative feature may be identified based on association of content of the live information source with the representative feature in a database. In some implementations additional factors related to the live information source may be utilized to rank the query suggestions.

### BACKGROUND

This specification is directed generally to ranking query suggestions for a partial query, and more particularly, to ranking query suggestions based on one or more representative features of a live information source.

Information retrieval systems, such as Internet search engines, enable users to locate information in a large database. For example, Internet search engines enable users to access information such as web pages, images, text documents, and/or multimedia content in response to a search query submitted by a user consisting of one or more search terms.

Some information retrieval systems may provide one or more query suggestions to a user as the user is typing a query and/or after a user has submitted a query. The user may choose one of the query suggestions to utilize as a submitted query and/or to utilize as the basis for a submitted query (e.g., by modifying, adding to, and/or subtracting from the selected query suggestion). The query suggestions are often generated based on previously submitted queries of the user, previously submitted queries of other users, and/or automatically generated queries.

### SUMMARY

The present disclosure is directed to methods and apparatus for identifying a live information source and ranking query suggestions based on one or more representative features of the live information source. In some implementations, representative features may be identified directly from the live information source. In some implementations, representative features may be identified based on association of content of a live information source with one or more representative features in a database. In some implementations, additional factors related to the live information source may be utilized to rank query suggestions. For example, the ranking of query suggestions may be based on the time that the live information source is broadcast, the genre of the live information source, and/or the popularity of the live information source.

In some implementations a computer implemented method is provided that includes the steps of: identifying a live information source, wherein the live information source is available to multiple users; identifying a representative feature of the live information source; identifying a query; identifying a plurality of query suggestions, wherein the query suggestions are based on the query; ranking one or more of the query suggestions, the ranking of a given query suggestion of the query suggestions based on similarity between the given query suggestion and the representative feature; and selecting one or more of the query suggestions to provide in response to the query, the selecting of the one or more of the query suggestions based on the ranking.

This method and other implementations of technology disclosed herein may each optionally include one or more of the following features.

The live information source may be a television program. The representative feature may be identified via textual information of the live information source. The live information source may be a video source and the textual information may be a closed captioning feed of the video source. The live information source may be a video source and the representative feature may be identified via image recognition of one or more images of the live information source.

The ranking of one or more of the query suggestions may include determining a relevance score for the query suggestions. The relevance score for each of the query suggestions may be based on a received base relevance score that is modified based on similarities between the query suggestions and the query.

The query may be a partial query and the plurality of query suggestions may be autocomplete query suggestions. The representative feature may be identified based on association of content of the live information source to the representative feature in an entity database.

The method may further include the step of identifying associated information of the live information source, wherein the associated information may be indicative of additional aspects of the live information source that are not identifiable directly from the live information source, and wherein the ranking may be based on the associated information. The associated information may be a time interval when the live information source is available to view. The associated information may be popularity data for the live information source.

The method may further include identifying a query spike related to the given query suggestion; wherein the ranking of the given query suggestion is based on the query spike.

The method may further include the steps of: identifying a live feed time, wherein the live feed time may be indicative of a time when the live information source was presented live; and ranking one or more of the query suggestions, wherein the ranking may be based on the time passage from the live feed time. The live feed time may be based on one of a live information source start time, a live information source end time, and a viewing window time, wherein the viewing window time is indicative of an expected time within which a threshold of the multiple users will view the live information source. The ranking may include decreasing the likelihood of selecting a given query suggestion as the time passage from the live feed time increases.

In some implementations, a computer implemented method may be provided and includes the steps of: identifying a potential search query spike associated with a search query, wherein the search query spike is indicative of a number of users submitting the search query exceeding a threshold; identifying a live information source, wherein the live information source is available to multiple users; identifying a representative feature of the live information source; and determining whether the potential search query spike is an actual search query spike based on similarity between the given query suggestion and the representative feature.

The method may further include the steps of: providing the search query to a user when the potential query spike is determined to be an actual search query spike. The search query may be provided as a query suggestion to a search query provided by the user.

Other implementations may include a non-transitory computer readable storage medium storing instructions executable by a processor to perform a method such as one or more of the methods described herein. Yet another implementation may include a system including memory and one or more processors operable to execute instructions, stored in the memory, to perform a method such as one or more of the methods described herein.

Particular implementations of the subject matter described herein rank one or more query suggestions based on similarities between the query suggestions and a representative feature of a live information source. These ranking represent new aspects of query suggestions that are based on information obtained via a live information source. Particular implementations of the subject matter described herein may further identify a spike in the popularity of a query and verify the validity of the query spike by determining whether the query spike corresponds to content of one or more live information sources. These verifications represent new aspects of query spikes that are based on information obtained via a live information source.

It should be appreciated that all combinations of the foregoing concepts and additional concepts discussed in greater detail herein are contemplated as being part of the inventive subject matter disclosed herein. For example, all combinations of claimed subject matter appearing at the end of this disclosure are contemplated as being part of the inventive subject matter disclosed herein.

### BRIEF DESCRIPTION OF THE DRAWINGS

FIG. 1 is a block diagram of an example environment in which an implementation of a method of ranking query suggestions based on a live information source may be implemented.

FIG. 2 is a flow chart illustrating an example method of ranking search query suggestions based on a representative feature of a live information source.

FIG. 3 is a flow chart illustrating another example method of ranking query suggestions based on a representative feature of a live information source.

FIG. 4A illustrates a partial screenshot of an example environment that can be used to provide query suggestion results to a user.

FIG. 4B illustrates another partial screenshot of an example environment can be used to provide query suggestions based on a representative feature of a live information source.

FIG. 5 illustrates a block diagram of an example computer system.

### DETAILED DESCRIPTION

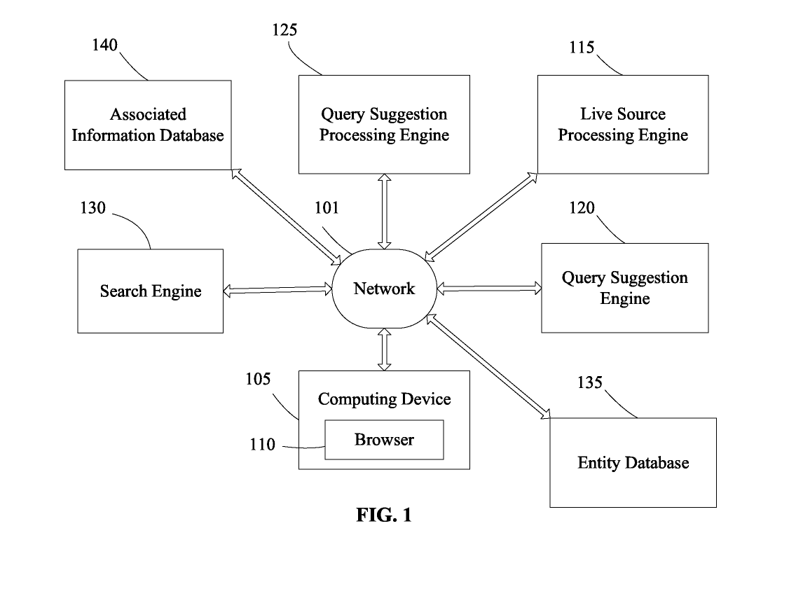

Referring to FIG. 1, a block diagram is illustrated of an example environment in which implementations of a method of ranking query suggestions based on a live information source may be implemented. The environment includes computing device 105 with a web browser 110, search engine 130, live source processing engine 115, query suggestion engine 120, query suggestion processing engine 125, entity database 135, and associated information database 140. The environment also includes a communication network 101 that enables communication between various components of the environment.

In some implementations, a live information source may be provided to an audience for viewing. Live information sources include television broadcasts, streaming Internet broadcasts, radio broadcasts, Internet radio broadcasts, and/or other information sources that are provided to an audience in real time. For example, one or more television networks may broadcast a television feed of an event as the event occurs, and an audience for the event may view the broadcast as it is being provided. Also, for example, one or more television networks may broadcast a television feed of a television series, and an audience for the television series may view the broadcast as it is being provided. In some implementations, a live information source may be provided to subsets of the audience at varying times and/or via alternative broadcast methods. For example, a broadcast television feed may be broadcast in the eastern United States at a certain time and broadcast to the western United States at a different time. Also, for example, live information may be broadcast utilizing a television broadcast and an Internet broadcast, either simultaneously or at different times. In some implementations the live information source may be provided to the user via communication network 101, such as through computing device 105 and/or through a television receiver.

Live source processing engine 115 may identify a live information source that is being provided to an audience from one or more live transmissions. Examples of live information sources include television broadcasts, internet live streaming video, terrestrial radio broadcasts, and/or satellite radio broadcasts. The live source processing engine 115 may further identify one or more representative features of the live information source based on one or more content sources associated with the live information source. Content sources include closed captioning of a broadcast, phonetic analysis of the audio of a broadcast, phonetic analysis of a video description service associated with a video broadcast, image analysis of a video broadcast, and/or metadata associated with a live information source. In some implementations, live source processing engine 115 may provide one or more representative features of a live broadcast source to query suggestion processing engine 125 and/or query suggestion engine 120.

In some implementations, live source processing engine 115 may identify a representative feature directly from one or more content sources associated with the live information source and provide query suggestion engine 115 with the representative feature. In some implementations, live source processing engine 115 may identify a representative feature based on association in a database of the representative feature with content derived via the content sources. For example, live source processing engine 115 may identify an alias and/or additional information associated with an entity based on one or more content sources of the live information source. The live source processing engine 115 may identify the entity that is associated with the alias and/or additional information via accessing one or more database such as entity database 135. One or more additional properties associated with the entity, additional entities associated with the entity, and/or one or more additional properties associated with associated entities may be utilized as the representative feature. For example, an alias associated with the entity for “Actor 1” may be identified from a live television show and utilized to identify the entity for “Actor 1”. Actor 1's spouse may be identified and the alias of the spouse may be utilized as the representative feature.

In some implementations, live source processing engine 115 may identify representative features based on a transcription of the live information source, such as a closed captioning feed that is broadcast with the live information source. For example, a television broadcast may include closed captioning and live source processing engine 115 may analyze the closed captioning to identify one or more representative features of the live information source. For example, live source processing engine 115 may identify terms such as words and/or phrases in the closed captioning as representative features. Identification of a term as a representative feature may be based on the weighting of that term. For example, in some implementations weighting of a term may be based on one or more of: when in the live information source the term occurs, how often the term occurs, the context of the term with other terms, and/or presence of the term proximal to identified keywords. Additional and/or alternative weightings may additionally and/or alternatively be utilized such as term frequency inverse document frequency (TFIDF) weighting.

In some implementations, live source processing engine 115 may identify representative features and/or identifying properties based on phonetic analysis of an audio broadcast and/or an audio of a video broadcast. In some implementations, live source processing engine 115 may process an audio source into a format which, in some implementations, is more easily searched for representative features. For example, live source processing engine 115 may transcribe an audio source into text utilizing phonetic recognition so that representative features and/or identifying properties may be identified as described herein.

In some implementations, live source processing engine 115 may identify representative features and/or identifying properties based on analysis of images provided in a video broadcast. In some implementations, the live source processing engine 115 may identify the contents of an image displayed in a video broadcast that is potentially important and search a database of images to determine the identity of the displayed image. For example, a video broadcast may display an image of the face of a person; live source processing engine 115 may compare the image to a database of images and corresponding features of the image; and identify a representative feature and/or identifying property based on features of the image. In some implementations, live source processing engine 115 may use image recognition to identify text that is present in a video broadcast. For example, live source processing engine 115 may identify a caption in a video broadcast that includes the name of a person who is currently being displayed.

In some implementations, live source processing engine 115 may identify representative features and/or identifying properties based on metadata associated with the live information source. Metadata may include data that is not audible and/or visible in a live information source, but may be provided along with the live information source. For example, an Internet streaming broadcast may be provided to the browser 110 through a webpage. The webpage may additionally include HTML tags and/or XML tags in the associated source code of the webpage. Live source processing engine 115 may identify one or more representative features and/or identifying properties from information that is embedded in the source code of the webpage, such as the title of the broadcast, the source of the broadcast, the genre of the broadcast, the topic of the broadcast, performers in the broadcast, etc.

As discussed herein, in some implementations, live source processing engine 115 may utilize identified content of the live information source to identify one or more properties associated with one or more entities from an entity database, such as entity database 135. In some implementations entities are topics of discourse. In some implementations, entities are persons, places, concepts, and/or things that can be referred to by a text fragment (e.g., a term or phrase) and are distinguishable from one another (e.g., based on context). For example, the text “bush” on a webpage may potentially refer to multiple entities such as President George Herbert Walker Bush, President George Walker Bush, a shrub, and the rock band Bush. Also, for example, the text “sting” may refer to the musician Gordon Matthew Thomas Sumner or the wrestler Steve Borden.

In some implementations an entity may be referenced by a unique entity identifier that may be used to identify the entity. The unique entity identifier may be associated with one or more properties associated with the entity. For example, in some implementations the entity database 135 may include properties associated with unique identifiers of one or more entities. For example, a unique identifier for the entity associated with the wrestler Steve Borden may be associated with a name or alias property of “Sting”, another alias property of “Steve Borden”, and/or an occupation property of “wrestler in the entity properties database 135. Additional and/or alternative properties may be associated with an entity in one or more databases such as entity database 135.

In some implementations, live source processing engine 115 may utilize identified content from a live information source to identify a representative feature from the entity database 135 based on similarity between identified content and a property of an entity. In some implementations, live source processing engine 115 may provide one or more identified entity properties associated with a live information source to query suggestion processing engine 125 and/or query suggestion engine 120 as a representative feature of the live information source. In some implementations similarity between identified content of a live information source and an entity property may be determined based on a mapping between the content and the entity property. For example, the live source processing engine 115 may identify that a live information source is a broadcast of the State of the Union speech. The live processing engine 115 may identify the content “State of the Union” based on one or more methods described herein, such as analysis of closed captioning text, identification of words in a caption present in a video feed, and/or through metadata associated with the live information source. The live source processing engine 115 may identify the entity associated with the “State of the Union” based on similarities between the identified property and the name of the entity, and provide query suggestion engine 120 and/or query suggestion processing engine 125 with a property of the entity associated with the “State of the Union” and/or a property associated with an entity associated with the “State of the Union.” For example, “State of the Union” may include the property “President of the United States,” and live source processing engine 115 may provide query processing engine 120 with the property “President of the United States,” as a representative feature of the live information source.

The computing device 105 executes one or more applications, such as web browsers (e.g., web browser 110), that enable the user to formulate queries and submit completed queries to the search engine 130. In some implementations, queries may be submitted directly to the search engine 130 from the computing device 105. In some implementations, completed queries may be submitted to the search engine 130 from the query suggestion engine 120.

The search engine 130 receives a query and executes the query against a search engine content database of available documents, such as webpages, images, text documents, and/or multimedia. The search engine 130 identifies content which matches the submitted query and responds by generating search results that are transmitted to one or more devices in a form that is useful for the devices. For example, in response to a query from the computing device 105, the search engine 130 may transmit a plurality of search results to be displayed in the web browser 110 that is executing on the computing device 105 based on available documents from a content database. A content database may include one or more storage mediums. For example, in some implementations, a content database may include multiple computer servers each containing one or more storage mediums.

Applications executing on the computing device 105 may also provide partial queries being formulated by users before the users have indicated completion of the queries. The applications may be, for example, a web browser 110, a toolbar running in the web browser 110, an email application, a text messaging application, and/or a search client running on the computing device 105. In some implementations, the applications provide each character of the query as it is typed or otherwise entered by the user. In some implementations, the applications provide multiple characters at a time, optionally following a pause by the user between character entries.

A partial query is a query formulated by a user prior to an indication by the user that the query is a completed query. In some implementations, a user may indicate a completed query by entering a carriage return and/or other character. In some implementations, a user may indicate a completed query by selecting a search button or other submission button in a user interface presented to the user. In some implementations, a user may indicate a completed query by speaking a command in a speech user interface. In some implementations, a user may indicate a completed query by pausing more than a predetermined amount of time during entering of the query. Other forms of providing a partial query and/or indicating a completed query may additionally and/or alternatively be utilized.

In response to a partial query entered by a user, the computing device 105 may facilitate entry of user input by providing suggested inputs to the user. For example, when the user enters one or more characters, the computing device 105 can provide query suggestions that are selected using the one or more characters. In some implementations, the query suggestions may be provided to the computing device 105 by query suggestion engine 120 and/or query suggestion processing engine 125. The query suggestions that are provided may include words or phrases that include the one or more characters that were entered by the user. For example, complete words or extended phrases can be suggested for partial words or partial phrases that a user has entered (e.g., using a physical or virtual keyboard). The query suggestions can also include words or phrases that are similar to (e.g., synonyms or spelling corrections of) the user input. The user can interact with (e.g., tap, click, or otherwise affirmatively select) one of the provided query suggestions to enter the text of the selected query suggestion.

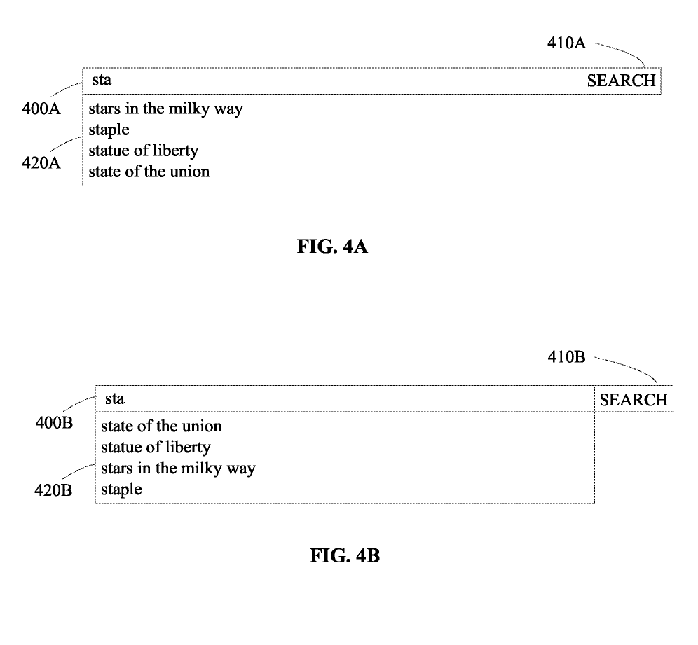

The query suggestions may be displayed to a user in a user interface of the computing device 105. For example, the query suggestions may be displayed within a cascaded drop down menu of the search field of an application, such as a web browser executing on the computing device 105, as the user is typing the query, such as the partial user interface that is illustrated in FIGS. 4A and 4B and described herein. Also, for example, the query suggestions may be displayed in a plurality of separately selectable cells arranged in one or more rows or columns in a user interface as the user is typing the query. For example, query suggestions that were identified based on a live information source may be displayed in a column separate from other query suggestions. In some implementations, one or more search results for a query suggestion may also optionally be displayed as the user is typing the query.

In some implementations, in response to a partial query being entered at computing device 105, the search engine 130 may receive the query and forward the partial query to the query suggestion engine 120. In some implementations, in response to a query being entered at computing device 105, the one or more applications executing on the computing device 105 may optionally directly forward the query to the query suggestion engine 120. For example, in some implementations, the browser 110 may directly forward the partial query to the query suggestion engine 120. The query suggestion engine 120 may include memory for storage of data and software applications, a processor for accessing data and executing applications, and components that facilitate communication over the communication network 101. The query suggestion engine 120 may match a submitted partial query to one or more of a plurality of query suggestions that are an appropriate match to the query. In some implementations, the query suggestions may represent potential completed queries that may be provided to a user to enable the user to choose one of the query suggestions as a basis for utilization in a search or other information retrieval application.

In some implementations a query suggestion database may include one or more query suggestions that have been determined, scored, and/or sorted according to one or more methods and/or apparatus described herein. Such query suggestions may be provided to a user. In some implementations the query suggestion engine 120 and/or the live source processing engine 115 may provide the query suggestions to a user via the search engine 105, the query suggestion processing engine 125, and/or to the computing device 105 directly. In some implementations, the query suggestions may include those determined based on a list of previously submitted queries of one or more users, a list of automatically generated queries, and/or real time automatically generated queries. In some implementations, the query suggestions may include those identified based on data retrieved from a query suggestion database. For example, the query suggestion engine 120 may use prefix based matching to identify query suggestions from a list of past user queries and/or from matches to entries in the query suggestion database. Any listing of past user queries, representative features identified from a live information source, and/or past automatically generated queries may optionally be stored in a query suggestion database for potential utilization as query suggestions and/or as a basis for query suggestions. These autocomplete suggestions provided by the query suggestion engine 120 represent words or phrases that a user may want to include in addition to or instead of the partial queries actually being typed.

In some implementations the query suggestion engine 120 may provide query suggestions to the query suggestion processing engine 125. The query suggestion processing engine 125 may determine scores for one or more of the provided query suggestions; determine which query suggestions to provide to a user; and/or rank one or more of the provided query suggestions. In some implementations, the query suggestion processing engine 125 may determine scores for and/or rank search query suggestions based on the similarity between search query suggestions provided by the query suggestions engine 120 and representative features identified by live source processing engine 115, and/or based on the similarity between search query suggestions provided by the query suggestions engine 120 and properties of one or more entities that are related to a representative feature that were identified by live source processing engine 115 from the entity database 135.

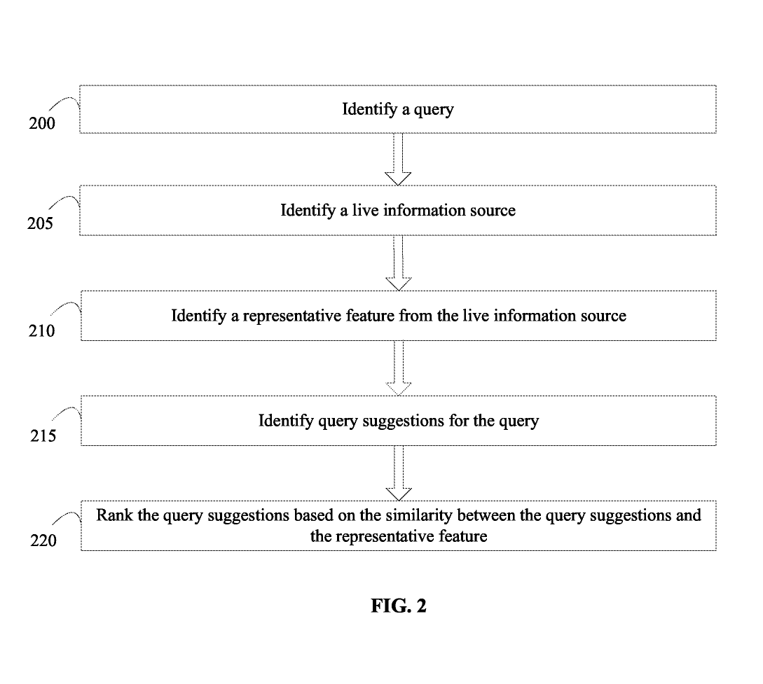

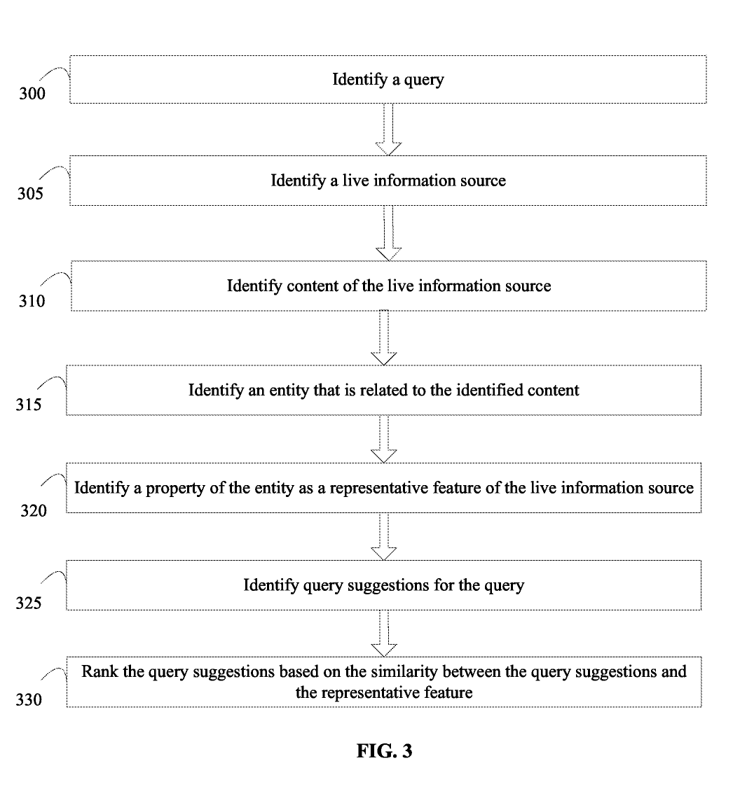

For example, the query suggestion processing engine 125 may determine scores for query suggestions based on one or more representative features of a live information source, which may be provided to query suggestion processing engine 125 by live source processing engine 115 and/or query suggestion engine 120. The query suggestions provided to the query suggestion processing engine 125 may optionally be provided with associated scores. Scores for the query suggestions and/or new scores for some of the provided query suggestions may be determined based at least in part on the provided representative features and/or additional associated information that is related to the live information source such as associated information from the associated information database 140. The determination of any scores for the query suggestions may include one or more aspects of the methods of FIGS. 2 and 3, such as steps 220 and/or 330.

In some implementations, the query suggestion processing engine 125 may rank one or more of the provided query suggestions based at least in part on scores assigned to each of such query suggestions. In some implementations, the ranking may additionally and/or alternatively be based on other factors such as the number of terms in the suggestions, the length of term(s) in the query suggestions, and/or display parameters of the computing device 105. In some implementations, the ranking of the query suggestions may be utilized to determine which query suggestions are provided to a user and/or in which order the query suggestions are displayed to the user.

In some implementations, the scoring and/or ranking of search query suggestions may be based on associated information that may be identified from an associated information database such as associated information database 140. Associated information may include the genre of a particular live information source, the popularity rating of a live information source, the demographics of likely viewers of a live information source, and/or the media providers of a live information source. Query suggestion processing engine 125 and/or query suggestion engine 120 may utilize associated information from associated information database 140 to determine whether to utilize representative features from a particular information source, the likely time interval to boost the ranking of search queries that share similarities with a particular information source, and/or the groups of users who may be likely to submit search queries that share similarities with representative features of a particular information source. For example, live source processing engine 115 may identify a live information source and further identify one or more representative features. Query suggestion processing engine 125 may identify association information that is relevant to the live information source and determine that, for example, the live information source has a low viewership. Accordingly, query suggestion processing engine 125 may not utilize representative features from the live information source and/or may reduce the effect of the representative features on the ordering and/or ranking of related query suggestions based on the determined low viewership of the live information source. Also, for example, query suggestion processing engine 125 may identify associated information that indicates that a particular live information source is viewed by a particular demographic and boost ordering and/or ranking of query suggestions that share similarities with the identified representative features for only users of the particular demographic.

In some implementations, the effect of an identified feature from a live information source and the ranking of one or more query suggestions may vary based on the time that a feature is identified and/or the time that a search query is submitted. In some implementations, one or more query suggestions may be boosted for the duration of all and/or only a portion of the live information source broadcast. For example, the ranking of one or more query suggestions may be boosted for a time period after the feature was identified in the live information source to anticipate a query spike in the submission of one or more search queries related to the identified feature. Also, for example, the ranking of one or more query suggestions may be boosted for the remainder of the live information source broadcast once a feature is identified. In some implementations, one or more query suggestions may continue to be boosted for a time after the broadcast of the live information source. For example, one or more query suggestions may be boosted for the twenty-four hours after a live information source broadcast.

In some implementations, the timeframe for boosting one or more query suggestions may be based on one or more features from the entity database 135 and/or from one or more entries that were received from the associated information database 140. For example, query suggestion engine 120 and/or query suggestion processing engine 125 may identify statistical information from the associated information database 140 that indicates that the genre of a live information source is typically viewed live and/or viewed via a recording of the live information source within twenty-four hours of the original presentation of the live information source, and boost one or more query suggestions related to the live information source for the twenty-four hours following the original broadcast of the live information source.

In some implementations, the likelihood that a query suggestion will be boosted may vary with time. For example, a query suggestion may be boosted in a ranking when a feature is identified from a live information source that is related to the query suggestion, remain at the same ranking for a time period, and then returned to the initial ranking of the query suggestion at a later time. In some implementations, rankings of one or more query suggestions may be boosted for a time period after the live broadcast and the effect of the boosting may be inversely proportional to the time since a feature was identified. For example, a sporting event may be likely to trigger search queries related to the sporting event during the broadcast and for the twenty four hours after the event. The ranking may be boosted to a constant level for the entire twenty-four hours and/or may gradually decline over the twenty-four hour period. Also, for example, the query suggestion processing engine 125 may promote the ranking of one or more query suggestions when a feature is identified and promote the query suggestion fewer places in the ordering of query suggestions gradually over twenty-four hours (e.g., promote four places immediately following the broadcast, three places after 8 hours, two places after 16 hours, etc.). Also, for example, a score associated with a query suggestion may be increased when a feature is first identified and decreased over a time period (e.g., promote to 2.0 at immediately following the broadcast, 1.8 after 8 hours, 1.6 after 16 hours, etc.). Information related to the viewing habits of users may be included in the associated information database 140.

In some implementations, one or more modules may identify elevated submissions of one or more queries that are related to the live information source. In some implementations, query suggestion processing engine 125 may adjust one or more query suggestion rankings based on a spike in particular query suggestion submissions. For example, a module may identify an increased usage of the search query “house of representatives” during a broadcast of the State of the Union. Live source processing engine 115 may analyze the identified live information source to determine whether the term “house of representatives” is a representative feature of the live information source. In some implementations, live source processing engine 115 and/or query suggestion processing engine 125 may verify the importance of one or more identified representative features of a live information source by analyzing a plurality of received search queries to determine whether the identified representative feature corresponds to a spike in recent submitted search queries. For example, live source processing engine 115 may identify “House of Representatives” as a representative feature of the live information source. In some implementations, live source processing engine 115 and/or query suggestion processing engine 125 may verify that “House of Representatives” is an important representative feature of the live information source by verifying that the number of recently submitted search queries that are related to “House of Representatives” has increased. For example, the submission of “House of Representatives” over a recent time period may be compared to an average number of submissions for that query over the time period.

In some implementations, identified representative features of a live information source may be utilized to verify the validity of a query spike. For example, one or more modules may detect an increased submission of one or more search queries. Live source processing engine 115 may provide the module with representative features identified from one or more recent live information sources to determine whether the recent search query spike is related to one or more live information sources. For example, a search query spike for queries related to “State of the Union” may be valid during a State of the Union speech and a module may verify with live source processing engine 115 that the increased usage of those queries is valid. Also, for example, a search query spike for queries related to “State of the Union” may be determined to not be a valid spike when the spike occurs sometime other than during the State of the Union speech. In some implementations representative features from a live information source may be utilized to lower a threshold of query spike needed to constitute a valid query spike. For example, in some implementations a query spike for queries related to “State of the Union” may not satisfy a threshold of query spike when a corresponding representative feature of a live information source is not identified, but may satisfy the threshold of query spike when an associate representative feature of a live information source is identified. Live source processing engine 115 may provide one or more modules with information regarding live information sources for further determination that the query spike is not due to regular search query usage.

In some implementations, the query suggestion processing engine 125 may provide the selected query suggestions, determined scores for one or more of the query suggestions, and/or the ranking of the query suggestions for storage in a query suggestion database. In some implementations, stored data may optionally be associated with a corresponding partial query in the database for future retrieval in response to a future query suggestion request for the partial query by one or more users. In some implementations the query suggestion engine 120 may supply existing query suggestions for a given partial query to query suggestion processing engine 125 to enable query suggestion processing engine 125 to score and/or rank such data for storage in a database for future retrieval. In some implementations, the query suggestion engine 120 may supply query suggestions for a real time query to enable query suggestion processing engine 125 to score and/or rank such data for providing query suggestions in response to the real time query. In some implementations, the query suggestion engine 120 may supply query suggestions for a real time query to enable query suggestion processing engine 125 to determine which of a plurality of supplied query suggestions to display in response to the real time query. In some implementations, the query suggestion processing engine 125 provides query suggestions to a user. In some implementations the query suggestion processing engine 125 may provide the query suggestions to a user via the search engine 130, the query suggestion engine 120, and/or to the computing device 105 directly.

In some implementations, the search engine 130 and/or the computing device 105 may optionally provide a completed query to the query suggestion engine 120. A completed query is a query that the user has indicated is complete. The query suggestion engine 120 may then match the completed query to one or more query suggestions to determine one or more query suggestions for the user's completed query. The query suggestion engine 120 and/or the query suggestion processing engine 125 then provides these query suggestions to the user. In some implementations the query suggestions may be provided to a user via the search engine 130, the query suggestion processing engine 125, and/or to the computing device 105 directly. The query suggestions may, for example, be embedded within a search results web page to be displayed in an application, such as the web browser 110, as potential further search options.

Many other configurations are possible having more or less components than the environment shown in FIG. 1. For example, although the query suggestion processing engine 125 and the query suggestion engine 120 are each illustrated alone in FIG. 1, it is understood that the query suggestion processing engine 125 and/or the query suggestion engine 120 may optionally be combined with one another and/or with one or more of the search engine 130 and/or the computing device 105 in some implementations.

Referring to FIG. 2, a flow chart illustrating an example method of ranking search query suggestions based on a representative feature of a live information source is provided. Other implementations may perform the steps in a different order, omit certain steps, and/or perform different and/or additional steps than those illustrated in FIG. 2. For convenience, aspects of FIG. 2 will be described with reference to a system of one or more computers that perform the process. The system may include, for example, the live source processing engine 115, the query suggestion engine 120 and/or the query suggestion processing engine 125 of FIG. 1.

At step 200, a query is identified. In some implementations the query may be identified from a log of past partial and/or completed queries. In some implementations the query may be entered by a user via a computing device executing a web browser, such as computing device 105 and web browser 110. In some implementations, the user may enter a complete search query into the web browser 110 and indicate that the query is complete, such as by clicking a search button and/or stopping typing for a predetermined period of time. In some implementations, the user may enter a partial search query in anticipation of receiving suggested queries. The completed and/or partial search queries may be provided to a search engine that shares one or more aspects with search engine 130.

At step 205, a live information source is identified. Live information sources include television broadcasts, streaming Internet broadcasts, radio broadcasts, Internet radio broadcasts, and/or other information sources that are provided to an audience in real time. In some implementations, live information sources may be identified by a module that shares one or more aspects with live source processing engine 115.

At step 210, a representative feature of the live source is identified. A representative feature may be identified based on one or more content sources associated with the live processing source as described herein. Content sources include closed captioning of a broadcast, phonetic analysis of the audio of a broadcast, phonetic analysis provided by a video description service associated with a video broadcast, image analysis of a video broadcast, and/or metadata associated with a live information source. In some implementations, a module sharing one or more characteristics with live source processing engine 115 may identify one or more representative features and provide representative features of a live broadcast source to query suggestion processing engine 125 and/or query suggestion engine 120. In some implementations, step 210 may share one or more aspects with one or more steps of the method of FIG. 3, such as step 310.

At step 215, a plurality of query suggestions responsive to the query identified at step 200 are identified. For example, for a partial query of “sta”, the query suggestions illustrated in FIG. 4A may be obtained. The query suggestions of FIG. 4A are illustrated in the drop-down box 420A. For the query “sta,” the query suggestions all contain “sta” as the prefix and contain additional text to form a complete word or phrase starting with “sta”. In some implementations the query suggestions may be transmitted to the query suggestion processing engine 125 from the query suggestion engine 120 via communications network 101. The query suggestions may be transmitted to the partial query suggestion engine 120 in response to a user entering a partial query on computing device 110.

At step 220, the query suggestions identified at step 215 are ranked based on the similarity of one or more of the query suggestions and the representative feature of the live information source that was identified at step 210. For example, live source processing engine 115 may identify a live broadcast of the State of the Union address and determine that “state of the union” was associated with the broadcast as described herein. “State of the union” may be boosted in rankings by a determined number of places; a score associated with the query suggestion may be increased; and/or the query suggestion may be provided as a query suggestion when it otherwise would not have been provided in a ranked list of provided query suggestions. Live information processing engine 115 may provide the aspect “state of the union” to query suggestion engine 120 and/or to a query suggestion database for use in future query searches. In some implementations, query suggestion processing engine 125 may receive identified representative features from live source processing engine 115, from query suggestion engine 120, and/or may retrieve one or more entities and/or aspects of entities from entity database 135.

In some implementations, the ranking of a query suggestion that shares similarities with a representative feature may be boosted by adjusting defined scores that are provided with the query suggestions. In some implementations similarity between a query suggestion and a representative feature may be determined based on one or more algorithms, such as a Levenshtein edit distance, a Jaro-Winkle edit distance, a Jaccard index, a Masi distance; and/or character counts between the text provided for the representative feature and the text of a query suggestion. Additional and/or alternative similarity comparisons may be utilized. For example, a database of terms and synonyms and/or related terms may be utilized. For example, “stars in the milky way” may have a defined score of 1.5 and “state of the union” may have a defined score of 1.0. Query suggestion processing engine 125 may adjust the score of “state of the union” to 2.0 based on the identified representative feature and boost “state of the union” above “stars in the milky way” in the ranking of query suggestions. In some implementations, the query suggestion processing engine 125 may boost a query suggestion that shares similarities with the identified representative feature a determined number of places in the ranking of query suggestions. For example, query suggestion processing engine 125 may boost query suggestions related to representative features of a live information source two places in the provided ranked query suggestions, which would rank “state of the union” above “stars in the milky way.”

Referring to FIG. 3, a flow chart illustrating an example method of ranking search query suggestions based on entities that are related to representative features of a live information source is provided. For convenience, aspects of FIG. 3 will be described with reference to a system of one or more computers that perform the process. The system may include, for example, the live source processing engine 115, the query suggestion engine 120 and/or the query suggestion processing engine 125 of FIG. 1.

At step 300, a query is identified. In some implementations, a query may be identified based on previous queries submitted by one or more users. In some implementations the search query may be entered by a user via a computing device executing a web browser, such as computing device 105 and web browser 110. In some implementations, the user may enter a complete search into the web browser 110 and indicate that the query is complete, such as by clicking a search button and/or stopping typing for a predetermined period of time. In some implementations, the user may enter a partial search query in anticipation of receiving suggested queries. The completed and/or partial search queries may be submitted to a search engine that may share one or more aspects with search engine 130. In some implementations, step 300 may share one or more aspects with steps of FIG. 2, such as step 200.

At step 305, a live information source is identified. Live information sources include television broadcasts, streaming Internet broadcasts, radio broadcasts, Internet radio broadcasts, and/or other information sources that are provided to an audience in real time. In some implementations, live information sources may be identified by a module that shares one or more aspects with live source processing engine 115. In some implementations, step 305 may share one or more aspects with steps of FIG. 2, such as step 205.

At step 310, a property of the live source is identified. An identified property may be identified from on one or more content sources associated with the live processing source as described herein. Content sources include closed captioning of a broadcast, phonetic analysis of the audio of a broadcast, phonetic analysis provided by a video description service associated with a video broadcast, image analysis of a video broadcast, and/or metadata associated with a live information source. In some implementations, a module sharing one or more characteristics with live source processing engine 115 may identify one or more properties of the live information source and provide the properties to query suggestion processing engine 125 and/or query suggestion engine 120. In some implementations, step 310 may share one or more aspects with one or more steps of the method of FIG. 2, such as step 210.

At step 315, an entity is identified that is related to the content that is identified in step 310. In some implementations the entity may be identified from a database of entities and entity properties as described herein. An entity database may share one or more characteristics with entity database 135 of FIG. 1. Entities may be identified by one or more modules that share one or more characteristics with the live processing engine 115.

At step 320, a property of the identified entity is identified as a representative feature of the live information source. In some implementations, a module sharing one or more characteristics with live source processing engine 115 may provide one or more entity properties of an entity as a representative feature to query suggestion processing engine 125 and/or query suggestion engine 120 as described herein. In some implementations, an entity properties database may include properties associated with unique identifiers of one or more entities. For example, a unique identifier for the entity associated with the State of the Union may be associated with a property of “speech”, another property of “President of the United States”, and/or a speech date of “Feb. 12, 2013” in an entity properties database that may share one or more characteristics with entity database 135. Additional and/or alternative properties may be associated with an entity in one or more databases such as entity database 135.

At step 325, a plurality of query suggestions responsive to the query identified at step 300 are identified. For example, for a partial query of “pre”, a plurality of query suggestions may be identified that includes “preamble,” “prenatal,” and “president of the united states.” For the query “pre,” the query suggestions all contain “pre” as the prefix and contain additional text to form a complete word or phrase starting with “pre”. In some implementations the query suggestions may be transmitted to the query suggestion processing engine 125 from the query suggestion engine 120 via communications network 101. The query suggestions may be transmitted to the partial query suggestion engine 120 in response to a user entering a partial query on computing device 110. In some implementations, step 325 may share one or more aspects with one or more steps of the method of FIG. 2, such as step 215.

At step 330, the query suggestions identified at step 325 are ranked based on the similarity of one or more of the query suggestions and the representative feature that was identified at step 315. For example, live source processing engine 115 may identify a live broadcast of the State of the Union address and determine that “state of the union” is associated with the broadcast utilizing one or more of the methods described here. Live source processing engine 115 may identify an entity that has a name property of “State of the Union.” The entity “State of the Union” may additionally include the property “President of the United States” and/or be associated with the entity “President of the United States.” One or more query suggestions that share a similarity with the entity property “President of the United States” may be boosted in rankings by a determined number of places and/or a score associated with the query suggestion may be increased and/or may be provided as a query suggestion when it otherwise would not have been provided in a ranked list of provided query suggestions. In some implementations, step 330 may share one or more aspects with one or more steps of the method of FIG. 2, such as step 220.

Although methods of ranking search query suggestions based representative features of live information sources are illustrated in the Figures, additional and/or alternative methods may be utilized to rank query suggestions based on one or more representative features of a live information source. Certain implementations of the methods of processing query suggestions have been described as taking place in a substantially real time environment. However, one or more aspects of methods described herein may be implemented in an offline mode. For example, implementations of methods described herein may be utilized to identify a representative feature of a live information source and rank and/or sort query suggestions based on the representative feature.

Referring to FIG. 4A, a partial screenshot of an example environment that can be used to provide query suggestion results to a user is provided. In FIG. 4A, the partial screen shot includes a search field representation 400A and a search button representation 410A. In this example, the user has entered the partial search query “sta” into the search field representation and a drop down menu 420A of the search field is displayed. A module that may share one or more characteristics with query suggestion engine 120 may identify one or more candidate query suggestions that may be associated with the prefix “sta.” The query suggestion engine 120 may identify query suggestions based on, for example, a list of past user queries, a list of automatically generated queries, and/or real time automatically generated queries. Query suggestion engine 120 and/or query suggestion processing engine 125 may associate a score with each identified query suggestion and rank the plurality query suggestions based on the associated scores. The drop down menu 420A includes four query suggestions that are based on the partial search query “sta.” Query suggestion engine 120 and/or query suggestion processing engine 125 may determine that “stars in the milky way” is the most likely query completion suggestion for searches beginning with the prefix “sta” based on a defined score associated with the search phrase “stars in the milky way.”

The user may optionally choose any of the query suggestions and utilize the suggestion as a completed query or the basis for a completed query to retrieve information based on the identified query suggestion. In some implementations, the user may request additional display sets of query suggestions to be displayed. For example, in some implementations a user may scroll within the drop down menu 420A to display one or more additional query suggestions from further display sets. In some implementations, the user may indicate that the search query that is entered into search field 400A is complete by selecting search button 410A. In some implementations, one or more of the query suggestions in drop down menu 420A may be clickable and the user may choose a search suggestion by selecting a suggestion in drop down menu 420A.

Referring to FIG. 4B, another partial screenshot of an example environment can be used to provide query suggestions based on a representative feature of a live information source is provided. In FIG. 4B, the partial screen shot includes a search field representation 400B and a search button representation 410B. The query suggestions in drop down menu 420B are the same query suggestions as the query suggestions in FIG. 4A with a different order. The ranking and/or ordering of the query suggestions in FIG. 4B may be based on one or more of the methods of ranking query suggestions based on a representative feature of a live information source as described herein. For example, “state of the union” may be boosted in the ordering and/or ranking based on a live broadcast of the State of the Union address and live source processing engine 115 identifying “state of the union” as a representative feature of the live information source and/or live source processing engine 115 identifying “state of the union” as an aspect of an entity that was identified based on a representative feature of a representative feature. “State of the union” may be provided to query suggestion engine 120 and/or query suggestion processing engine 125 to utilize in ranking and/or ordering one or more query suggestions.

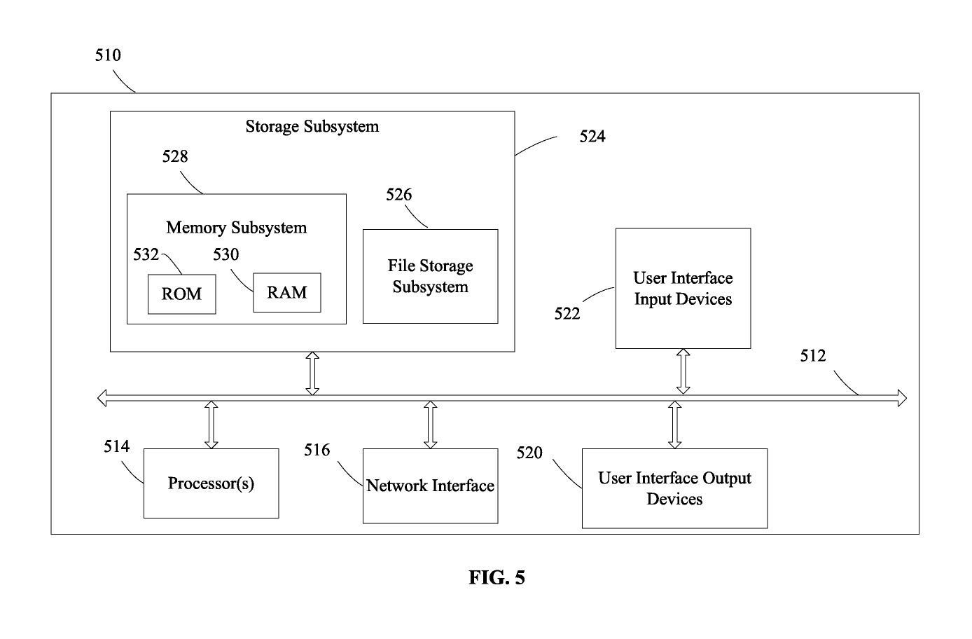

FIG. 5 is a block diagram of an example computer system 510. Computer system 510 typically includes at least one processor 514 which communicates with a number of peripheral devices via bus subsystem 512. These peripheral devices may include a storage subsystem 524, including, for example, a memory subsystem 526 and a file storage subsystem 528, user interface input devices 522, user interface output devices 520, and a network interface subsystem 516. The input and output devices allow user interaction with computer system 510. Network interface subsystem 516 provides an interface to outside networks and is coupled to corresponding interface devices in other computer systems.

User interface input devices 522 may include a keyboard, pointing devices such as a mouse, trackball, touchpad, or graphics tablet, a scanner, a touchscreen incorporated into the display, audio input devices such as voice recognition systems, microphones, and/or other types of input devices. In general, use of the term “input device” is intended to include all possible types of devices and ways to input information into computer system 510 or onto a communication network.

User interface output devices 520 may include a display subsystem, a printer, a fax machine, or non-visual displays such as audio output devices. The display subsystem may include a cathode ray tube (CRT), a flat-panel device such as a liquid crystal display (LCD), a projection device, or some other mechanism for creating a visible image. The display subsystem may also provide non-visual display such as via audio output devices. In general, use of the term “output device” is intended to include all possible types of devices and ways to output information from computer system 510 to the user or to another machine or computer system.

Storage subsystem 524 stores programming and data constructs that provide the functionality of some or all of the modules described herein. For example, the storage subsystem 524 may include the logic to identify a live information source and rank search query suggestions based on a representative feature of the live information source as described herein.

These software modules are generally executed by processor 514 alone or in combination with other processors. Memory 526 used in the storage subsystem can include a number of memories including a main random access memory (RAM) 530 for storage of instructions and data during program execution and a read only memory (ROM) 532 in which fixed instructions are stored. A file storage subsystem 528 can provide persistent storage for program and data files, and may include a hard disk drive, a floppy disk drive along with associated removable media, a CD-ROM drive, an optical drive, or removable media cartridges. The modules implementing the functionality of certain implementations may be stored by file storage subsystem 528 in the storage subsystem 524, or in other machines accessible by the processor(s) 514.

Bus subsystem 512 provides a mechanism for letting the various components and subsystems of computer system 510 communicate with each other as intended. Although bus subsystem 512 is shown schematically as a single bus, alternative implementations of the bus subsystem may use multiple busses.

Computer system 510 can be of varying types including a workstation, server, computing cluster, blade server, server farm, or any other data processing system or computing device. Due to the ever-changing nature of computers and networks, the description of computer system 510 depicted in FIG. 5 is intended only as a specific example for purposes of illustrating some implementations. Many other configurations of computer system 510 are possible having more or fewer components than the computer system depicted in FIG. 5.

While several inventive implementations have been described and illustrated herein, a variety of other means and/or structures for performing the function and/or obtaining the results and/or one or more of the advantages described herein may be utilized, and each of such variations and/or modifications is deemed to be within the scope of the inventive implementations described herein. More generally, all parameters, dimensions, materials, and configurations described herein are meant to be exemplary and that the actual parameters, dimensions, materials, and/or configurations will depend upon the specific application or applications for which the inventive teachings is/are used. Those skilled in the art will recognize, or be able to ascertain using no more than routine experimentation, many equivalents to the specific inventive implementations described herein. It is, therefore, to be understood that the foregoing implementations are presented by way of example only and that, within the scope of the appended claims and equivalents thereto, inventive implementations may be practiced otherwise than as specifically described and claimed. Inventive implementations of the present disclosure are directed to each individual feature, system, article, material, kit, and/or method described herein. In addition, any combination of two or more such features, systems, articles, materials, kits, and/or methods, if such features, systems, articles, materials, kits, and/or methods are not mutually inconsistent, is included within the inventive scope of the present disclosure.

All definitions, as defined and used herein, should be understood to control over vocabulary definitions, definitions in documents incorporated by reference, and/or ordinary meanings of the defined terms.

The indefinite articles “a” and “an,” as used herein in the specification and in the claims, unless clearly indicated to the contrary, should be understood to mean “at least one.”

The phrase “and/or,” as used herein in the specification and in the claims, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one implementation, to A only (optionally including elements other than B); in another implementation, to B only (optionally including elements other than A); in yet another implementation, to both A and B (optionally including other elements); etc.

As used herein in the specification and in the claims, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of,” or, when used in the claims, “consisting of,” will refer to the inclusion of exactly one element of a number or list of elements. In general, the term “or” as used herein shall only be interpreted as indicating exclusive alternatives (i.e. “one or the other but not both”) when preceded by terms of exclusivity, such as “either,” “one of,” “only one of,” or “exactly one of.” “Consisting essentially of,” when used in the claims, shall have its ordinary meaning as used in the field of patent law.

As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one implementation, to at least one, optionally including more than one, A, with no B present (and optionally including elements other than B); in another implementation, to at least one, optionally including more than one, B, with no A present (and optionally including elements other than A); in yet another implementation, to at least one, optionally including more than one, A, and at least one, optionally including more than one, B (and optionally including other elements); etc.

It should also be understood that, unless clearly indicated to the contrary, in any methods claimed herein that include more than one step or act, the order of the steps or acts of the method is not necessarily limited to the order in which the steps or acts of the method are recited.

What is claimed is:

1. A method comprising:
identifying a live information source, wherein the live information source is available to multiple users;
identifying a representative feature of the live information source;
identifying a query formulated independently of the live information source;
identifying a plurality of query suggestions, wherein the query suggestions are based on the query;
ranking one or more of the query suggestions, the ranking of a given query suggestion of the query suggestions based on similarity between the given query suggestion and the representative feature; and
selecting one or more of the query suggestions to provide in response to the query, the selecting of the one or more of the query suggestions based on the ranking.

2. The method of claim 1, wherein the live information source is a television program.

3. The method of claim 1, wherein the representative feature is identified via textual information of the live information source.

4. The method of claim 2, wherein the live information source is a video source and the textual information is a closed captioning feed of the video source.

5. The method of claim 1, wherein the live information source is a video source and the representative feature is identified via image recognition of one or more images of the live information source.

6. The method of claim 1, wherein the ranking one or more of the query suggestions includes determining a relevance score for the query suggestions.

7. The method of claim 6, wherein the relevance score for each of the query suggestions is based on a received base relevance score that is modified based on similarities between the query suggestions and the query.

8. The method of claim 1, wherein the query is a partial query and the plurality of query suggestions are autocomplete query suggestions.

9. The method of claim 1, wherein the representative feature is identified based on association of content of the live information source to the representative feature in an entity database.

10. The method of claim 1, further comprising:
identifying associated information of the live information source, wherein the associated information is indicative of additional aspects of the live information source that are not identifiable directly from the live information source, and wherein the ranking is based on the associated information.

11. The method of claim 10, wherein the associated information is a time interval when the live information source is available to view.

12. The method of claim 10, wherein the associated information is popularity data for the live information source.

13. The method of claim 1, further comprising:
identifying a query spike related to the given query suggestion;
wherein the ranking of the given query suggestion is based on the query spike.

14. The method of claim 1, further comprising:
identifying a live feed time, wherein the live feed time is indicative of a time when the live information source was presented live; and
ranking one or more of the query suggestions, wherein the ranking is based on the time passage from the live feed time.

15. The method of claim 1, wherein the ranking of a given query suggestion of the query suggestions is based on similarity between text of the given query suggestion and text provided for the representative feature.

16. The method of claim 14, wherein the ranking includes decreasing a likelihood of selecting a given query suggestion as the time passage from the live feed time increases.

17. A method comprising:
identifying a potential search query spike associated with a search query, wherein the search query spike is indicative of a number of users submitting the search query exceeding a threshold;
identifying a live information source, wherein the live information source is available to multiple users;
identifying a representative feature of the live information source; and
determining whether the potential search query spike is an actual search query spike based on similarity between the search query and the representative feature;
wherein the search query is formulated independently of the live information source.

18. The method of claim 17, further comprising providing the search query to a user when the potential query spike is determined to be an actual search query spike.

19. The method of claim 18, wherein the search query is provided as a query suggestion to a search query provided by the user.

20. A system including memory and one or more processors operable to execute instructions stored in the memory, wherein the instructions include instructions to:
identify a live information source, wherein the live information source is available to multiple users;
identify a representative feature of the live information source;
identify a query;
identify a plurality of query suggestions, wherein the query suggestions are based on the query;
rank one or more of the query suggestions, the ranking of a given query suggestion of the query suggestions based on similarity between text of the given query suggestion and text provided for the representative feature; and
select one or more of the query suggestions to provide in response to the query, the selecting of the one or more of the query suggestions based on the ranking.

21. The system of claim 20, wherein the similarity is determined using a Levenshtein edit distance, a Jaro-Winkle edit distance, a Jaccard index, a Masi distance, or character counts between the text provided for the representative feature and the text of the given query suggestion.

22. The system of claim 20, wherein the instructions further include instructions to:
identify associated information of the live information source, wherein the associated information is indicative of additional aspects of the live information source that are not identifiable directly from the live information source, and wherein the ranking is based on the associated information.

23. The system of claim 20, wherein the instructions further include instructions to:
identify a live feed time, wherein the live feed time is indicative of a time when the live information source was presented live; and
rank one or more of the query suggestions, wherein the ranking is based on the time passage from the live feed time.

24. The system of claim 23, wherein the live feed time is based on one of a live information source start time, a live information source end time, and a viewing window time, wherein the viewing window time is indicative of an expected time within which a threshold of the multiple users will view the live information source.

25. The system of claim 24, wherein the ranking includes decreasing the likelihood of selecting a given query suggestion as the time passage from the live feed time increases.
